(19) United States
(12) Patent Application Publication
(10) Pub. No.: US 2024/0289159 A1
(43) Pub. Date: Aug. 29, 2024

(54) MEMORY DEVICE VIRTUALIZATION

(71) Applicant: Micron Technology, Inc., Boise, ID (US)

(72) Inventors: Gaurav SINHA, Unterschleißheim (DE); Marco REDAELLI, Munich (DE)

(21) Appl. No.: 18/586,008

(22) Filed: Feb. 23, 2024

Related U.S. Application Data
(60) Provisional application No. 63/486,775, filed on Feb. 24, 2023.

(51) Int. Cl. G06F 9/455; G06F 8/61

(52) U.S. Cl. CPC G06F 9/45558; G06F 8/61; G06F 2009/45562; G06F 2009/45579

(57) ABSTRACT

Implementations described herein relate to memory device virtualization. In some implementations, a memory device may perform a boot-up of the memory device and may receive configuration information associated with a single root input-output virtualization for the memory device. The memory device may store the configuration information in a memory of the memory device. The memory device may perform a subsequent boot-up of the memory device. The memory device may retrieve the configuration information from the memory of the memory device after performing the subsequent boot-up of the memory device. The memory device may initiate one or more virtual functions associated with the single root input-output virtualization based on retrieving the configuration information from the memory of the memory device.

### CROSS-REFERENCE TO RELATED APPLICATION

This patent application claims priority to U.S. Provisional Patent Application No. 63/486,775, filed on Feb. 24, 2023, and entitled “MEMORY DEVICE VIRTUALIZATION.” The disclosure of the prior Application is considered part of and is incorporated by reference into this patent application.

### TECHNICAL FIELD

The present disclosure generally relates to memory devices, memory device operations, and, for example, to memory device virtualization.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of memory device virtualization.

FIG. 2 is a diagram of example components included in a memory device.

FIG. 3 is a diagram illustrating an example of a system boot using a single root input-output virtualization feature of a memory device.

FIG. 4 is a diagram illustrating an example of memory device virtualization.

FIG. 5 is a diagram illustrating an example of a virtualization architecture.

FIG. 6 is a flowchart of an example method associated with memory device virtualization.

FIG. 7 is a flowchart of an example method associated with memory device virtualization.

### DETAILED DESCRIPTION

Single root input-output virtualization (SR-IOV) may allow for an isolation of resources, such as peripheral component interconnect express (PCIe) resources, to improve resource manageability and system performance. SR-IOV may make different virtual functions available to different virtual components of a PCIe device. The PCIe device may be, for example, a solid state drive (SSD) or a graphics processing unit (GPU), among other examples. Physical functions associated with the SR-IOV may have the ability to move data in and out of the PCIe device, whereas virtual functions of the SR-IOV may support data flow while having a limited set of configuration resources.

Applications, such as automotive and embedded applications, may use virtualization techniques that leverage SR-IOV on PCIe devices. Once the SR-IOV is configured and enabled on the device, one or more virtual machines may be able to directly access the device through a virtual function without requiring a hypervisor or other software in the path of virtual machine and the PCIe device. Current approaches for SR-IOV require the use of the hypervisor to configure and enable the SR-IOV upon each power up of the device. In some cases, a virtualization architecture for the PCIe device, such as in the example of the automotive and embedded applications, may be fixed. For example, the virtualization architecture may require four virtual functions on an SR-IOV capable device that hosts four virtual machines. However, the device may still need to be configured with the SR-IOV configuration each time the memory device is booted up, even though the virtualization architecture may generally be unchanging. This may increase the boot-up time of the device and may increase the complexity of the system architecture and implementation.

Some implementations described herein enable storing an SR-IOV configuration in a memory of the memory device. In some implementations, a host device may access a physical function of the memory device, determine that the physical function of the memory device supports an SR-IOV for the memory device, and transmit SR-IOV configuration information to the memory device. The memory device may receive the SR-IOV configuration information and may store the SR-IOV configuration information in the memory of the memory device. After storing the SR-IOV configuration information in the memory of the memory device, the memory device may be booted down. For example, the memory device may experience a power loss or may perform a shutdown or restart operation. The memory device may perform a subsequent boot-up of the memory device, access the SR-IOV configuration from the memory of the memory device, and initiate one or more virtual functions associated with the SR-IOV configuration based on the SR-IOV configuration that is stored in the memory of the memory device. By storing the SR-IOV configuration in the memory of the memory device, the memory device may not need to be configured with the SR-IOV configuration upon each boot-up of the memory device. Instead, the memory device may access the SR-IOV configuration from the memory, and may initiate one or more virtual functions based on the SR-IOV configuration that is stored in the memory of the memory device without using a hypervisor. This may reduce the boot-up time of the memory device, reduce the complexity of the system architecture and implementation, and result in more efficient manufacturing. Additional details are described herein.

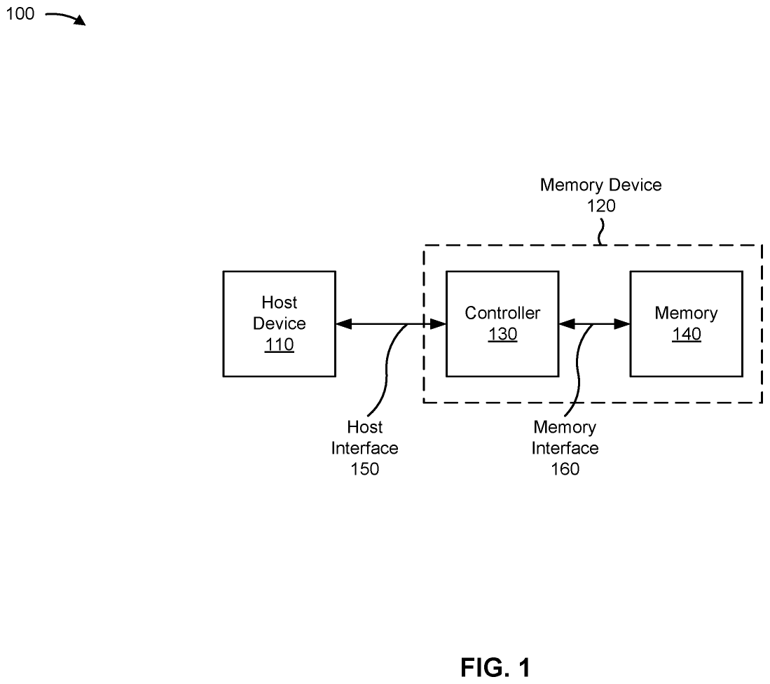

FIG. 1 is a diagram illustrating an example system 100 capable of memory device virtualization. The system 100 may include one or more devices, apparatuses, and/or components for performing operations described herein. For example, the system 100 may include a host device 110 and a memory device 120. The memory device 120 may include a controller 130 and memory 140. The host device 110 may communicate with the memory device 120 (e.g., the controller 130 of the memory device 120) via a host interface 150. The controller 130 and the memory 140 may communicate via a memory interface 160.

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host device 110 may include one or more processors configured to execute instructions and store data in the memory 140. For example, the host device 110 may include a central processing unit (CPU), a GPU, a field-programmable gate array (FPGA), an application-specific integrated circuit (ASIC), and/or another type of processing component.

The memory device 120 may be any electronic device or apparatus configured to store data in memory. In some implementations, the memory device 120 may be an electronic device configured to store data persistently in non-volatile memory. For example, the memory device 120 may be a hard drive, an SSD, a flash memory device (e.g., a NAND flash memory device or a NOR flash memory device), a universal serial bus (USB) thumb drive, a memory card (e.g., a secure digital (SD) card), a secondary storage device, a non-volatile memory express (NVMe) device, and/or an embedded multimedia card (eMMC) device. In this case, the memory 140 may include non-volatile memory configured to maintain stored data after the memory device 120 is powered off. For example, the memory 140 may include NAND memory or NOR memory. In some implementations, the memory 140 may include volatile memory that requires power to maintain stored data and that loses stored data after the memory device 120 is powered off, such as one or more latches and/or random-access memory (RAM), such as dynamic RAM (DRAM) and/or static RAM (SRAM). For example, the volatile memory may cache data read from or to be written to non-volatile memory, and/or may cache instructions to be executed by the controller 130.

The controller 130 may be any device configured to communicate with the host device (e.g., via the host interface 150) and the memory 140 (e.g., via the memory interface 160). Additionally, or alternatively, the controller 130 may be configured to control operations of the memory device 120 and/or the memory 140. For example, the controller 130 may include control logic, a memory controller, a system controller, an ASIC, an FPGA, a processor, a microcontroller, and/or one or more processing components. In some implementations, the controller 130 may be a high-level controller, which may communicate directly with the host device 110 and may instruct one or more low-level controllers regarding memory operations to be performed in connection with the memory 140. In some implementations, the controller 130 may be a low-level controller, which may receive instructions regarding memory operations from a high-level controller that interfaces directly with the host device 110. As an example, a high-level controller may be an SSD controller, and a low-level controller may be a non-volatile memory controller (e.g., a NAND controller) or a volatile memory controller (e.g., a DRAM controller). In some implementations, a set of operations described herein as being performed by the controller 130 may be performed by a single controller (e.g., the entire set of operations may be performed by a single high-level controller or a single low-level controller). Alternatively, a set of operations described herein as being performed by the controller 130 may be performed by more than one controller (e.g., a first subset of the operations may be performed by a high-level controller and a second subset of the operations may be performed by a low-level controller).

The host interface 150 enables communication between the host device 110 and the memory device 120. The host interface 150 may include, for example, a Small Computer System Interface (SCSI), a Serial-Attached SCSI (SAS), a Serial Advanced Technology Attachment (SATA) interface, a PCIe interface, an NVMe interface, a USB interface, a Universal Flash Storage (UFS) interface, and/or an embedded multimedia card (eMMC) interface.

The memory interface 160 enables communication between the memory device 120 and the memory 140. The memory interface 160 may include a non-volatile memory interface (e.g., for communicating with non-volatile memory), such as a NAND interface or a NOR interface. Additionally, or alternatively, the memory interface 160 may include a volatile memory interface (e.g., for communicating with volatile memory), such as a double data rate (DDR) interface.

In some implementations, one or more systems, devices, apparatuses, components, and/or controllers of FIG. 1 may be configured to perform a boot-up of the memory device; receive configuration information associated with a single root input-output virtualization for the memory device; store the configuration information in a memory of the memory device; perform a subsequent boot-up of the memory device; retrieve the configuration information from the memory of the memory device after performing the subsequent boot-up of the memory device; and initiate one or more virtual functions associated with the single root input-output virtualization based on retrieving the configuration information from the memory of the memory device.

In some implementations, one or more systems, devices, apparatuses, components, and/or controllers of FIG. 1 may be configured to store configuration information, associated with a single root input-output virtualization, after a boot-up of the memory device; retrieve the configuration information after a subsequent boot-up of the memory device; and initiate one or more virtual functions associated with the single root input-output virtualization based on retrieving the configuration information.

In some implementations, one or more systems, devices, apparatuses, components, and/or controllers of FIG. 1 may be configured to access a physical function of a memory device; determine that the physical function of the memory device supports a single root input-output virtualization for the memory device; and transmit configuration information to the memory device associated with the single root input-output virtualization. Additionally, one or more systems, devices, apparatuses, components, and/or controllers of FIG. 1 may be configured to perform a boot-up of the memory device; receive the configuration information associated with the single root input-output virtualization; store the configuration information in a memory of the memory device; perform a subsequent boot-up of the memory device; retrieve the configuration information from the memory of the memory device after performing the subsequent boot-up of the memory device; and initiate one or more virtual functions associated with the single root input-output virtualization based on retrieving the configuration information from the memory of the memory device.

As indicated above, FIG. 1 is provided as an example. Other examples may differ from what is described with regard to FIG. 1.

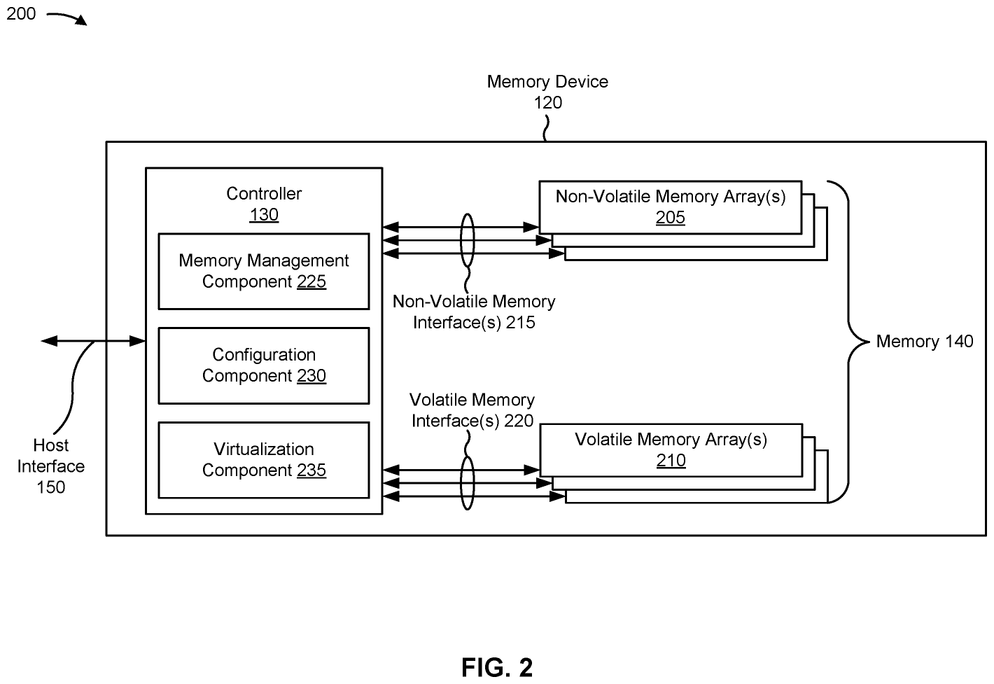

FIG. 2 is a diagram of example components included in a memory device 120. As described above in connection with FIG. 1, the memory device 120 may include a controller 130 and memory 140. As shown in FIG. 2, the memory 140 may include one or more non-volatile memory arrays 205, such as one or more NAND memory arrays and/or one or more NOR memory arrays. Additionally, or alternatively, the memory 140 may include one or more volatile memory arrays 210, such as one or more SRAM arrays and/or one or more DRAM arrays. The controller 130 may transmit signals to and receive signals from a non-volatile memory array 205 using a non-volatile memory interface 215. The controller 130 may transmit signals to and receive signals from a volatile memory array 210 using a volatile memory interface 220.

The controller 130 may control operations of the memory 140, such as by executing one or more instructions. For example, the memory device 120 may store one or more instructions in the memory 140 as firmware, and the controller 130 may execute those one or more instructions. Additionally, or alternatively, the controller 130 may receive one or more instructions from the host device 110 via the host interface 150, and may execute those one or more instructions. In some implementations, a non-transitory computer-readable medium (e.g., volatile memory and/or non-volatile memory) may store a set of instructions (e.g., one or more instructions or code) for execution by the controller 130. The controller 130 may execute the set of instructions to perform one or more operations or methods described herein. In some implementations, execution of the set of instructions, by the controller 130, causes the controller 130 and/or the memory device 120 to perform one or more operations or methods described herein. In some implementations, hardwired circuitry is used instead of or in combination with the one or more instructions to perform one or more operations or methods described herein. Additionally, or alternatively, the controller 130 and/or one or more components of the memory device 120 may be configured to perform one or more operations or methods described herein. An instruction is sometimes called a “command.”

For example, the controller 130 may transmit signals to and/or receive signals from the memory 140 based on the one or more instructions, such as to transfer data to (e.g., write or program), to transfer data from (e.g., read), and/or to erase all or a portion of the memory 140 (e.g., one or more memory cells, pages, sub-blocks, blocks, or planes of the memory 140). Additionally, or alternatively, the controller 130 may be configured to control access to the memory 140 and/or to provide a translation layer between the host device 110 and the memory 140 (e.g., for mapping logical addresses to physical addresses of a memory array). In some implementations, the controller 130 may translate a host interface command (e.g., a command received from the host device 110) into a memory interface command (e.g., a command for performing an operation on a memory array).

As shown in FIG. 2, the controller 130 may include a memory management component 225, a configuration component 230, and/or a virtualization component 235. In some implementations, one or more of these components are implemented as one or more instructions (e.g., firmware) executed by the controller 130. Alternatively, one or more of these components may be implemented as dedicated integrated circuits distinct from the controller 130.

The memory management component 225 may be configured to manage performance of the memory device 120. For example, the memory management component 225 may perform wear leveling, bad block management, block retirement, read disturb management, and/or other memory management operations. In some implementations, the memory device 120 may store (e.g., in memory 140) one or more memory management tables. A memory management table may store information that may be used by or updated by the memory management component 225, such as information regarding memory block age, memory block erase count, and/or error information associated with a memory partition (e.g., a memory cell, a row of memory, a block of memory, or the like).

The configuration component 230 may be configured to receive a virtualization configuration such as an SR-IOV configuration. The SR-IOV configuration may enable the memory device 120 to perform one or more virtual functions. In some implementations, the configuration component 230 may be configured to receive the SR-IOV configuration, such as during a one-time factory setup or a field update of the memory device 120, and to store the SR-IOV configuration in the memory 140 of the memory device 120. In some implementations, the configuration component 230 may be configured to retrieve the SR-IOV configuration from the memory 140 of the memory device 120.

The virtualization component 235 may be configured to perform the one or more virtual functions. For example, the virtualization component 235 may be configured to host one or more virtual machines on the memory device 120 that perform the one or more virtual functions. The virtualization component 235 may perform the one or more virtual functions and/or host the one or more virtual machines that perform the one or more virtual functions in accordance with the SR-IOV configuration, such as the received SR-IOV configuration and/or the stored SR-IOV configuration.

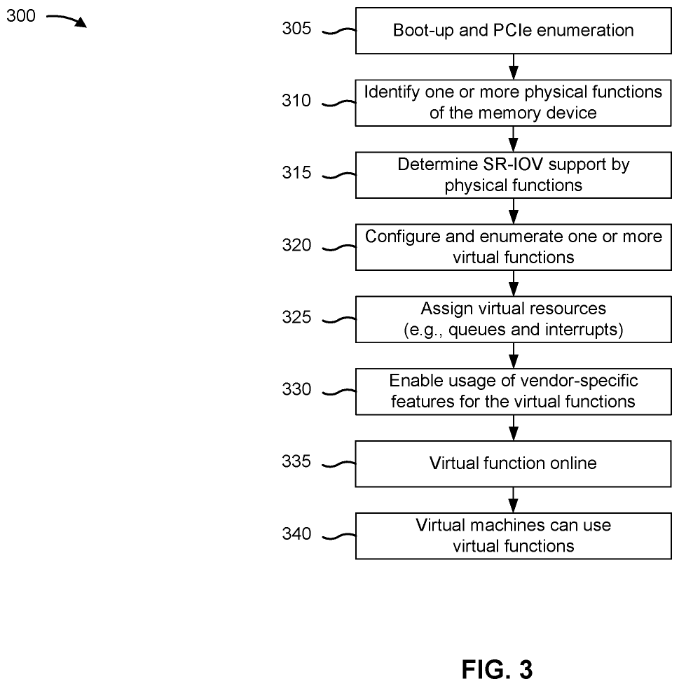

One or more devices or components shown in FIG. 2 may be configured to perform operations described herein, such as one or more operations and/or methods described in connection with FIGS. 3-6. For example, the controller 130, the memory management component 225, the configuration component 230, and/or the virtualization component 235 may be configured to perform one or more operations and/or methods for the memory device 120.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

As indicated above, FIG. 2 is provided as an example. Other examples may differ from what is described with regard to FIG. 2.

FIG. 3 is a diagram illustrating an example 300 of a system boot using a single root input-output virtualization feature of a memory device, in accordance with the present disclosure.

As shown by reference number 305, the memory device 120 and/or the controller 130 may perform a boot-up (e.g., a power-up) of the memory device 120. In the example that the memory device 120 is a PCIe device, the memory device 120 may perform a PCIe enumeration process. PCIe enumeration may include detecting one or more devices that are connected to a system. For example, PCIe enumeration may include detecting one or more devices that are connected to a PCIe bus, and selecting or assigning bus number(s) for the one or more devices that are connected to the PCIe bus.

As shown by reference number 310, the host device 110 may identify one or more physical functions of the memory device 120. A physical function may include an SR-IOV capability structure and may be used to manage the SR-IOV functionality of the memory device 120. Physical functions may be fully featured PCIe functions which are capable of being discovered, managed, and manipulated (e.g., similar to other PCIe devices). The physical functions may have full configuration capabilities and may be used to configure or control the PCIe device. In some cases, a physical function driver associated with a physical function may be visible in a root domain, may possess data movement capabilities, and/or may control an enabling or disabling of the SR-IOV capabilities of the PCIe device (e.g., using an application programming interface (API)).

As shown by reference number 315, the host device 110 may determine SR-IOV support by the one or more physical functions of the memory device 120. For example, the host device 110 may determine whether the physical functions of the memory device 120 support SR-IOV capabilities. Additionally, or alternatively, the host device 110 may determine one or more characteristics of the SR-IOV supported by the physical functions of the memory device 120.

As shown by reference number 320, the host device 110 may configure and enumerate one or more virtual functions for the memory device 120. A virtual function may be a PCIe function that shares one or more physical resources with a physical function. Unlike physical functions, a virtual function may only be able to configure behavior associated with that virtual function. An SR-IOV device may have one or more physical functions, and each physical function may be capable of supporting a number (e.g., hundreds or thousands) of virtual functions. The number of virtual functions that are supported may be dependent on the characteristics of the SR-IOV capable device. After the SR-IOV is enabled in the physical function, the PCIe configuration space of each virtual function can be accessed using the bus, device, and/or function number of the physical function. In some cases, each virtual function may have a PCIe memory space that is used for mapping a register set. Virtual function device drivers may operate on the register set to enable virtual functionality, which may enable the virtual function to appear as an actual PCIe device. After the creation of the virtual functions, the virtual functions may be assigned directly to an input/output (I/O) domain. This may enable the virtual function to share the physical device and to perform I/O operations without CPU and hypervisor software overhead. In some cases, a virtual function may be associated with a virtual machine that operates on the memory device 120. A virtual machine may be configured to perform one or more virtual functions for the memory device 120.

As shown by reference number 325, the host device 110 may assign one or more virtual resources. For example, the host device 110 may assign one or more virtual resources, such as queues and interrupts, among other examples, for hosting the virtual functions and/or the virtual machines that perform the virtual functions.

As shown by reference number 330, the host device 110 may enable usage of vendor-specific features for the virtual functions. The vendor-specific features may include, for example, parameters or conditions for the virtual functions that enable the virtual functions to perform in accordance with vendor requirements.

As shown by reference number 335, the virtual function may be made available online. The host device 110 and/or the memory device 120 may make the virtual function available online. This may enable the memory device 120 and/or the virtual machines hosted by the memory device 120 to use the virtual functions.

As shown by reference number 340, the virtual machines are able to use the virtual functions based on the virtual functions being configured and made available online.

As described above, the host device 110 may configure the memory device 120 with one or more virtual functions. For example, the host device 110 may identify the physical functions of the memory device 120, determine the SR-IOV supported by the physical functions, configure and enumerate the one or more virtual functions, assign the virtual resources, enable the usage of the vendor-specific features, and make the virtual function available online, after the memory device 120 has been booted up. In some cases, the memory device 120 may experience a power loss. For example, the memory device 120 may be voluntarily shutdown or restarted, or may lose power due to a battery failure, among other examples. When the memory device 120 is turned back on (for example, in a subsequent boot-up), the host device 110 may need to re-configure the memory device 120 with the virtual functions. For example, the host device 110 may need to perform some or all of the identification, determining, configuring, assigning, and enabling steps described above each time that the memory device 120 is booted up. As described above, this may increase the boot-up time of the memory device 120 and increase the complexity of the system architecture and implementation.

As indicated above, FIG. 3 is provided as an example. Other examples may differ from what is described with regard to FIG. 3.

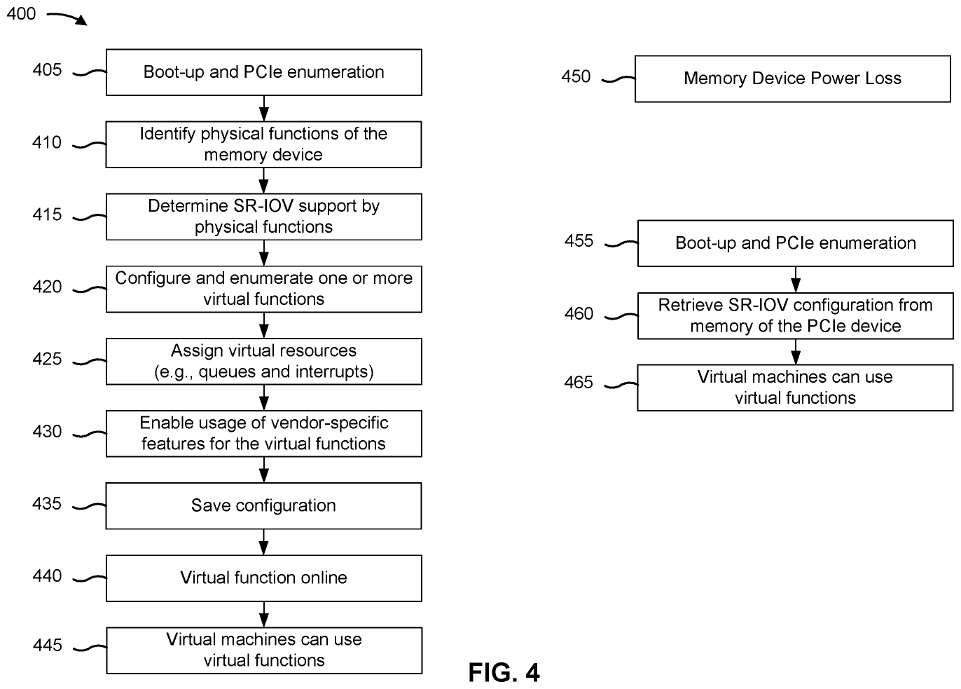

FIG. 4 is a diagram illustrating an example of memory device virtualization, in accordance with the present disclosure.

As shown by reference number 405 (and as described above in connection with reference number 305), the memory device 120 and/or the controller 130 may perform a boot-up of the memory device 120. In some implementations, the boot-up of the memory device 120 may be a partial boot-up that enables the memory device 120 to be configured with an SR-IOV configuration.

As shown by reference number 410 (and as described above in connection with reference number 310), the host device 110 may identify one or more physical functions of the memory device 120.

As shown by reference number 415 (and as described above in connection with reference number 315), the host device 110 may determine SR-IOV support by the one or more physical functions of the memory device 120.

As shown by reference number 420 (and as described above in connection with reference number 320), the host device 110 may configure and enumerate one or more virtual functions for the memory device 120.

As shown by reference number 425 (and as described above in connection with reference number 325), the host device 110 may assign one or more virtual resources for the virtual functions.

As shown by reference number 430 (and as described above in connection with reference number 330), the host device 110 may enable usage of vendor-specific features for the virtual functions.

As shown by reference number 435, the memory device 120 may save the SR-IOV configuration. For example, the memory device 120 may store the SR-IOV configuration in the memory 140 of the memory device 120. This may enable the memory device 120 to retrieve the SR-IOV configuration from the memory 140 and to initiate one or more virtual functions without needing to be re-configured each time the memory device 120 is booted up. In some implementations, the memory device 120 may automatically store the SR-IOV configuration in the memory 140 based on the memory device 120 being configured with the SR-IOV configuration. In some other implementations, the memory device 120 may receive a command or a register indication that indicates for the memory device 120 to store the SR-IOV configuration in the memory 140. Additionally, or alternatively, the command or register indication may indicate for the memory device 120 to keep the SR-IOV configuration persistent in the memory 140 until the SR-IOV configuration is explicitly modified (e.g., via a subsequent SR-IOV configuration, command, or register indication).

As shown by reference number 440 (and as described above in connection with reference number 335), the virtual function may be made available online.

As shown by reference number 445 (and as described above in connection with reference number 340), the virtual machines are able to use the virtual functions based on the virtual functions being configured and made available online.

As shown by reference number 450, the memory device 120 may experience a power loss. For example, the memory device 120 may be voluntarily shutdown or restarted, or may lose power due to a battery failure, among other examples.

As shown by reference number 455, the memory device 120 may perform a boot-up. In the example that the memory device 120 is a PCIe device, the memory device 120 may perform a PCIe enumeration process.

As shown by reference number 460, the memory device 120 may retrieve the SR-IOV configuration from the memory 140 of the memory device 120. The memory device 120 may not need to be re-configured with the SR-IOV configuration (as described above in connection with reference numbers 405, 410, 415, 420, 425, and 430). Instead, the memory device 120 may retrieve or access the SR-IOV configuration from the memory 140 of the memory device 120.

As shown by reference number 465, the virtual machines may be able to use the virtual functions based on the virtual functions being configured and made available online. The virtual machines may use the virtual functions based on the SR-IOV configuration that is stored in the memory 140 of the memory device 120. As described herein, the memory device 120 does not need to be re-configured with the SR-IOV configuration since the virtual machines and memory device may use the SR-IOV configuration that is stored in the memory 140 of the memory device 120. Thus, the memory device 120 may initiate the virtual functions (and/or host the virtual machines) without the use of a hypervisor or other software to perform the SR-IOV configuration. This may reduce the boot-up time of the memory device 120, reduce the complexity of the system architecture and implementation, and result in more efficient manufacturing.

As indicated above, FIG. 4 is provided as an example. Other examples may differ from what is described with regard to FIG. 4.

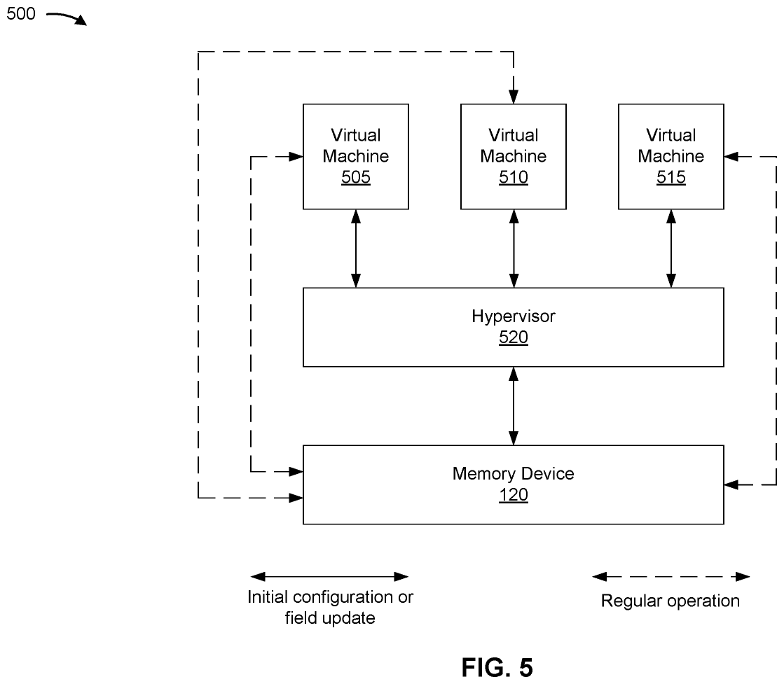

FIG. 5 is a diagram illustrating an example 500 of a virtualization architecture, in accordance with the present disclosure. The memory device 120 may communicate with one or more virtual machines, such as virtual machine 505, virtual machine 510, and virtual machine 515. Each virtual machine may be configured to perform one or more operations of the memory device using a respective virtual function. The memory device 120 may communicate with the virtual machines using an SR-IOV configuration. During an initial SR-IOV configuration, the memory device 120 may communicate with the virtual machines using a hypervisor 520 (and/or software that performs similar functions as the hypervisor 520). The hypervisor 520, which may also be referred to as a virtual machine monitor, may include software that creates and hosts (or enables the memory device 120 to create and host) the virtual machines. The hypervisor 520 may allow the memory device 120 to support multiple virtual machines by virtually sharing resources, such as memory and processing resources, with the virtual machines.

During the initial SR-IOV configuration, such as the one-time factory setup or the field update for the memory device 120, the hypervisor 520 may configure the memory device 120 with the SR-IOV configuration and may enable the memory device 120 to communicate with the virtual machines. Thus, the memory device 120 may communicate with the virtual machine 505, the virtual machine 510, and/or the virtual machine 515 via the hypervisor 520 (as shown by the solid lines). In some implementations described herein, the memory device 120 may store the SR-IOV configuration in the memory 140 of the memory device 120. When the memory device 120 performs a subsequent boot-up (for example, after experiencing a power loss), the memory device 120 may retrieve the SR-IOV configuration from the memory 140. The memory device 120 may communicate with the virtual machines directly (as shown by the dashed lines) using the SR-IOV configuration that is stored in the memory 140. Thus, the memory device 120 may communicate directly with the virtual machine 505, the virtual machine 510, and/or the virtual machine 515 without the use of the hypervisor 520.

As indicated above, FIG. 5 is provided as an example. Other examples may differ from what is described with regard to FIG. 5.

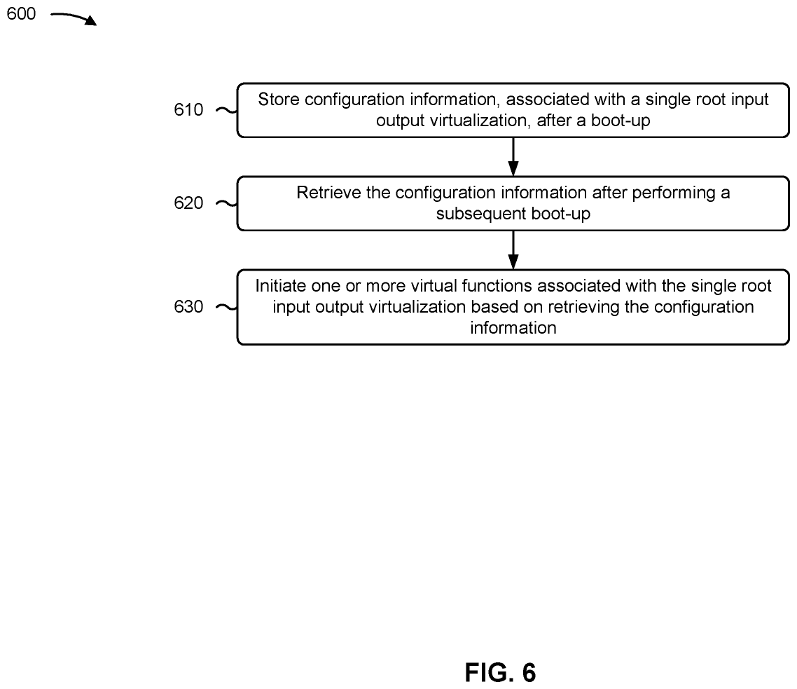

FIG. 6 is a flowchart of an example method 600 associated with memory device virtualization. In some implementations, a memory device (e.g., the memory device 120) may perform or may be configured to perform the method 600. In some implementations, another device or a group of devices separate from or including the memory device (e.g., the system 100) may perform or may be configured to perform the method 600. Additionally, or alternatively, one or more components of the memory device (e.g., the controller 130, the memory management component 225, the configuration component 230, and/or the virtualization component 235) may perform or may be configured to perform the method 600. Thus, means for performing the method 600 may include the memory device and/or one or more components of the memory device. Additionally, or alternatively, a non-transitory computer-readable medium may store one or more instructions that, when executed by the memory device (e.g., the controller 130 of the memory device 120), cause the memory device to perform the method 600.

As shown in FIG. 6, the method 600 may include storing configuration information, associated with a single root input-output virtualization, after a boot-up (block 610). As further shown in FIG. 6, the method 600 may include retrieving the configuration information after a subsequent boot-up (block 620). As further shown in FIG. 6, the method 600 may include initiating one or more virtual functions associated with the single root input-output virtualization based on retrieving the configuration information (block 630).

The method 600 may include additional aspects, such as any single aspect or any combination of aspects described below and/or described in connection with one or more other methods or operations described elsewhere herein.

In a first aspect, the method 600 includes receiving the configuration information from a host device after the boot-up.

In a second aspect, alone or in combination with the first aspect, the method 600 includes performing a shut-down operation or a restart operation after storing the configuration information and prior to the subsequent boot-up.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

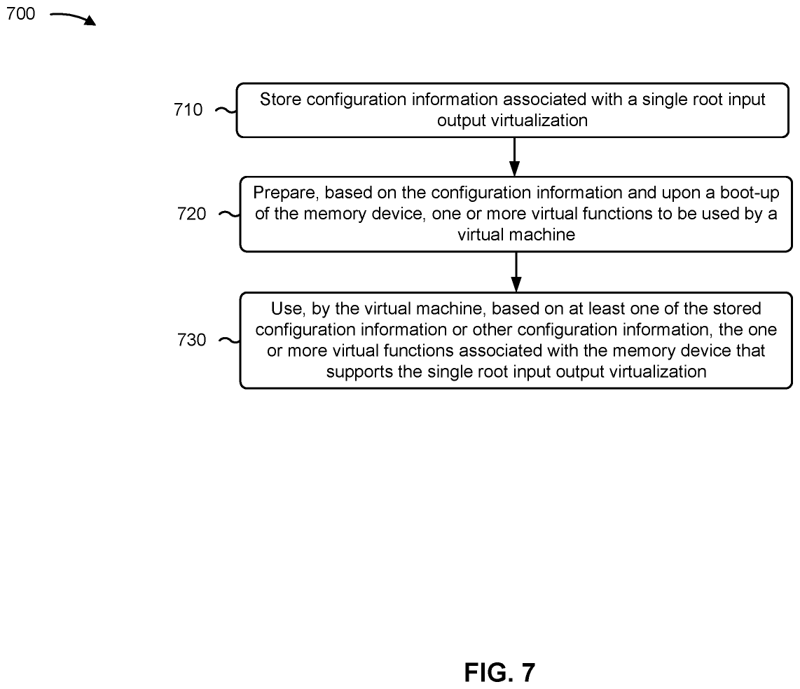

FIG. 7 is a flowchart of an example method 700 associated with memory device virtualization. In some implementations, a memory device (e.g., the memory device 120) may perform or may be configured to perform the method 700. In some implementations, another device or a group of devices separate from or including the memory device (e.g., the system 100) may perform or may be configured to perform the method 700. Additionally, or alternatively, one or more components of the memory device (e.g., the controller 130, the memory management component 225, the configuration component 230, and/or the virtualization component 235) may perform or may be configured to perform the method 700. Thus, means for performing the method 700 may include the memory device and/or one or more components of the memory device. Additionally, or alternatively, a non-transitory computer-readable medium may store one or more instructions that, when executed by the memory device (e.g., the controller 130 of the memory device 120), cause the memory device to perform the method 700.

As shown in FIG. 7, the method 700 may include storing configuration information associated with a single root input-output virtualization (block 710). As further shown in FIG. 7, the method 700 may include preparing, based on the configuration information and upon a boot-up of the memory device, one or more virtual functions to be used by a virtual machine (block 720). As further shown in FIG. 7, the method 700 may include using, by the virtual machine, based on at least one of the configuration information or other configuration information, the one or more virtual functions associated with the memory device that supports the single root input-output virtualization (block 730).

Although FIG. 7 shows example blocks of a method 700, in some implementations, the method 700 may include additional blocks, fewer blocks, different blocks, or differently arranged blocks than those depicted in FIG. 7. Additionally, or alternatively, two or more of the blocks of the method 700 may be performed in parallel. The method 700 is an example of one method that may be performed by one or more devices described herein. These one or more devices may perform or may be configured to perform one or more other methods based on operations described herein.

In some implementations, a memory device includes one or more components configured to: perform a boot-up of the memory device; receive configuration information associated with a single root input-output virtualization for the memory device; store the configuration information in a memory of the memory device; perform a subsequent boot-up of the memory device; retrieve the configuration information from the memory of the memory device after performing the subsequent boot-up of the memory device; and initiate one or more virtual functions associated with the single root input-output virtualization based on retrieving the configuration information from the memory of the memory device.

In some implementations, an apparatus includes means for storing configuration information, associated with a single root input-output virtualization, after a boot-up of the apparatus; means for retrieving the configuration information after a subsequent boot-up of the apparatus; and means for initiating one or more virtual functions associated with the single root input-output virtualization based on retrieving the configuration information.

In some implementations, a system includes a host device configured to: access a physical function of a memory device; determine that the physical function of the memory device supports a single root input-output virtualization for the memory device; and transmit configuration information to the memory device associated with the single root input-output virtualization; and the memory device, wherein the memory device is configured to: perform a boot-up of the memory device; receive the configuration information associated with the single root input-output virtualization; store the configuration information in a memory of the memory device; perform a subsequent boot-up of the memory device; retrieve the configuration information from the memory of the memory device after performing the subsequent boot-up of the memory device; and initiate one or more virtual functions associated with the single root input-output virtualization based on retrieving the configuration information from the memory of the memory device.

In some implementations, an apparatus includes means for storing configuration information associated with a single root input-output virtualization; means for preparing, based on the configuration information and upon a boot-up of the apparatus, one or more virtual functions to be used by a virtual machine; and means for using, by the virtual machine, based on at least one of the configuration information or other configuration information stored in the apparatus, the one or more virtual functions associated with the apparatus that supports the single root input-output virtualization.

In some implementations, a memory device is configured to store configuration information associated with a single root input-output virtualization; prepare, based on the configuration information and upon a boot-up of the memory device, one or more virtual functions to be used by a virtual machine; and use, by the virtual machine, based on at least one of the configuration information or other configuration information stored in the memory device, the one or more virtual functions associated with the memory device that supports the single root input-output virtualization.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
one or more components configured to:
perform a boot-up of the memory device;
receive configuration information associated with a single root input-output virtualization for the memory device;
store the configuration information in a memory of the memory device;
perform a subsequent boot-up of the memory device;
retrieve the configuration information from the memory of the memory device after performing the subsequent boot-up of the memory device; and
initiate one or more virtual functions associated with the single root input-output virtualization based on retrieving the configuration information from the memory of the memory device.

2. The memory device of claim 1, wherein the one or more components, to initiate the one or more virtual functions, are configured to host a virtual machine that is configured to perform the one or more virtual functions.

3. The memory device of claim 1, wherein the one or more components, to initiate the one or more virtual functions, are configured to initiate the one or more virtual functions associated with the single root input-output virtualization without using a hypervisor.

4. The memory device of claim 1, wherein the one or more components, to receive the configuration information, are configured to receive configuration information that configures the memory device with the one or more virtual functions, enumerates the one or more virtual functions, assigns one or more virtual resources for the one or more virtual functions, and enables one or more vendor-specific features for the one or more virtual functions.

5. The memory device of claim 1, wherein the one or more components, after storing the configuration information in the memory of the memory device, and prior to performing the subsequent boot-up of the memory device, perform a shutdown operation or a restart operation for the memory device or experience a power loss associated with the memory device.

6. The memory device of claim 1, wherein the one or more components are further configured to receive a register indication or a command that indicates to keep the single root input-output virtualization persistent until the single root input-output virtualization is explicitly modified.

7. The memory device of claim 1, wherein the one or more components, to receive the configuration information, are configured to receive the configuration information during a one-time factory setup or a field update associated with the memory device.

8. The memory device of claim 7, wherein the boot-up of the memory device is a partial boot-up of the memory device.

9. The memory device of claim 1, wherein the one or more components, after performing the subsequent boot-up of the memory device, are configured to:
perform a peripheral component interconnect express enumeration; and
enable the single root input-output virtualization for the memory device.

10. The memory device of claim 1, wherein the one or more components, to initiate the one or more virtual functions, are configured to initiate the one or more virtual functions without receiving additional configuration information from a host device.

11. An apparatus, comprising:
means for storing configuration information, associated with a single root input-output virtualization, after a boot-up of the apparatus;
means for retrieving the configuration information after a subsequent boot-up of the apparatus; and
means for initiating one or more virtual functions associated with the single root input-output virtualization based on retrieving the configuration information.

12. The apparatus of claim 11, further comprising means for receiving the configuration information from a host device after the boot-up of the apparatus.

13. The apparatus of claim 11, further comprising means for performing a shut-down operation or a restart operation after storing the configuration information and prior to the subsequent boot-up of the apparatus.

14. A system, comprising:
a host device configured to:
access a physical function of a memory device;
determine that the physical function of the memory device supports a single root input-output virtualization for the memory device; and
transmit configuration information to the memory device associated with the single root input-output virtualization; and
the memory device, wherein the memory device is configured to:
perform a boot-up of the memory device;
receive the configuration information associated with the single root input-output virtualization;
store the configuration information in a memory of the memory device;
perform a subsequent boot-up of the memory device;
retrieve the configuration information from the memory of the memory device after performing the subsequent boot-up of the memory device; and
initiate one or more virtual functions associated with the single root input-output virtualization based on retrieving the configuration information from the memory of the memory device.

15. The system of claim 14, wherein the host device, to transmit the configuration information to the memory device, is configured to transmit configuration information that configures the memory device with the one or more virtual functions, enumerates the one or more virtual functions, assigns one or more virtual resources for the one or more virtual functions, and enables one or more vendor-specific features for the one or more virtual functions.

16. The system of claim 14, wherein the memory device, to initiate the one or more virtual functions, is configured to host a virtual machine that is configured to perform the one or more virtual functions.

17. The system of claim 14, wherein the memory device, to initiate the one or more virtual functions, is configured to initiate the one or more virtual functions associated with the single root input-output virtualization without using a hypervisor.

18. The system of claim 14, wherein the host device is further configured to transmit, to the memory device, a register indication or a command that indicates for the memory device to keep the single root input-output virtualization persistent until the single root input-output virtualization is explicitly modified.

19. The system of claim 14, wherein the host device, to transmit the configuration information, is configured to transmit the configuration information during a one-time factory setup or a field update associated with the memory device.

20. The system of claim 14, wherein the memory device, to initiate the one or more virtual functions, is configured to initiate the one or more virtual functions without receiving additional configuration information from the host device.
